(19) United States
(12) Patent Application Publication
(10) Pub. No.: US 2022/0258836 A1
(43) Pub. Date: Aug. 18, 2022

(54) COVER LIFTER

(71) Applicant: Hall Equipment, LLC d/b/a Heyl & Patterson Equipment, Canonsburg, PA (US)

(72) Inventor: Paul Michael Hannan, Pittsburgh, PA (US)

(21) Appl. No.: 17/674,081

(22) Filed: Feb. 17, 2022

Related U.S. Application Data
(60) Provisional application No. 63/150,688, filed on Feb. 18, 2021.

(51) Int. Cl. B63B 17/02; B63B 35/28

(52) U.S. Cl. CPC B63B 17/02; B63B 35/28

(57) ABSTRACT

A lifting device for lifting a cover from a barge includes a main frame and one or more latch assemblies mounted to the main frame. Each latch assembly includes a hook for engaging an eyelet of the cover and an actuator for moving the hook into engagement with the eyelet. The lifting device further includes one or more indexers mounted to the main frame and/or the one or more latch assemblies for locating the main frame relative to the cover and/or the barge in a fore and aft direction of the barge and/or a side-to-side direction of the barge without the need for manual contact with the lifting device, the cover, or the barge.

### CROSS-REFERENCE TO RELATED APPLICATION

This application claims priority to U.S. Provisional Application No. 63/150,688, filed on Feb. 18, 2021, the disclosure of which is incorporated herein by reference in its entirety.

### BACKGROUND OF THE DISCLOSURE

### Field of the Disclosure

The present disclosure is related to a lifting device for lifting and lowering a cover on a barge with no or minimum manual handling of mechanical hardware of the lifting device.

### Description of Related Art

Many bulk materials that are shipped in river barges require the use of covers to keep them dry. During the loading of material onto barges, and during the removal of the material from the barges, the covers must be removed. In some embodiments, a cover may have four lifting rings positioned at its corners. Typically, connections between a cover lifting device and the lifting rings are completed manually. This requires a person to travel from the dock to the barge, and guide the lifting hooks from the overhead hoist that carries the cover lifting device into each of the four lifting rings. Additionally, when lowering the cover onto the barge, the cover typically must be manually manipulated relative to the barge in order to align the cover into its proper spot. This is a hazardous environment to work in. Accordingly, there is a need in the art for an improved lifting device configured for lifting and lowering the cover relative to the barge that overcomes the deficiencies of existing cover lifting devices.

SUMMARY OF THE DISCLOSURE

These needs and others are met by the non-limiting embodiments or aspects described herein, which are directed to an improved lifting device configured for lifting and lowering a cover from and onto a barge.

In some non-limiting embodiments or aspects of the present disclosure, a lifting device configured for lifting a cover from a barge and lowering the cover onto the barge may include a main frame and one or more latch assemblies mounted to the main frame, with each of the latch assemblies including a hook for engaging an eyelet of the cover, and an actuator for moving the hook into engagement with the eyelet. The lifting device may further include one or more indexers mounted to at least one of the main frame and the one or more latch assemblies, wherein each of the one or more indexers is configured for locating the main frame and/or the one or more latch assemblies relative to at least one of the cover and the barge in a length direction of the barge or a width direction of the barge.

In some non-limiting embodiments or aspects of the present disclosure, at least one of the one or more indexers may be configured to engage a top surface of the cover. At least one of the one or more indexers may be configured to be indexed relative to a topographical feature of the cover. At least one of the one or more indexers may include a wheel configured to extend at least partially into a corrugation of the cover.

In some non-limiting embodiments or aspects of the present disclosure, at least one of the one or more indexers may include a cover bumper that extends from the main frame and is configured for locating the main frame relative to the cover in the width direction of the barge. The cover bumper may include an inclined surface configured to engage a side surface of the cover and guide the main frame into position as the main frame is lowered towards the cover. The cover bumper may further include a horizontal stop surface configured for contacting a top surface of the cover. The cover bumper may hang below the one or more latch assemblies.

In some non-limiting embodiments or aspects of the present disclosure, at least one of the one or more indexers may include a locating arm configured for locating a front end or a rear end of the barge in the length direction of the barge. The locating arm may be adjustable between a first position wherein the locating arm contacts the front end or the rear end of the barge, and a second position wherein the locating arm is spaced apart from the front end or the rear end of the barge. An adjustment mechanism may be provided for moving the locating arm between the first position and the second position. A sensor may detect when the locating arm is in the first position.

In some non-limiting embodiments or aspects of the present disclosure, at least one of the one or more indexers may include a barge bumper that extends from the one or more latch assemblies and is configured for locating the one or more latch assemblies relative to the barge in the width direction of the barge. The barge bumper may include an inclined surface configured to engage the side surface of the barge and guide the one or more latch assemblies into position as the main frame is lowered towards the barge.

In some non-limiting embodiments or aspects of the present disclosure, the one or more latch assemblies may include a first pair of latch assemblies arranged on opposite ends of a first longitudinal side of the main frame, and a second pair of latch assemblies arranged on opposite ends of a second longitudinal side of the main frame. The one or more latch assemblies may include at least two latch assemblies on a first longitudinal side of the main frame, and at least one of the one or more indexers may be disposed between the two latch assemblies on the first longitudinal side of the main frame.

In some non-limiting embodiments or aspects of the present disclosure, the actuator of each latch assembly may be configured to move the hook of that latch assembly in a direction perpendicular to the fore and aft direction of the barge. The actuator may include a linear actuator or a motor and a gearbox.

In some non-limiting embodiments or aspects of the present disclosure, the hook of each of the latch assemblies may be slidably mounted within a guide channel. The hook of each of the latch assemblies may include at least one prong configured to rotate the eyelet relative to the cover as the hook engages the eyelet.

In some non-limiting embodiments or aspects of the present disclosure, a latch assembly for a barge cover lifting device may include a guide channel, a hook slideable within the guide channel and configured for engaging an eyelet of the cover, and an actuator for moving the hook into engagement with the eyelet.

In some non-limiting embodiments or aspects of the present disclosure, the actuator may include a linear actuator or a motor and a gearbox. The hook may be slideable in a horizontal direction within the guide channel. The hook may include at least one prong configured to rotate the eyelet relative to the cover as the hook engages the eyelet. The guide channel may include a linear or roller bearing surface supporting an upper section of the hook. The guide channel may include a slot through which the hook extends downward. The upper section of the hook that slides within the linear bearing surface may have a round cross section.

Various other non-limiting embodiments or aspects of the present disclosure are recited in one or more of the following clauses:

Clause 1. A lifting device configured for lifting a cover from a barge and lowering the cover onto the barge, the lifting device comprising: a main frame; one or more latch assemblies mounted to the main frame, each of the latch assemblies comprising: a hook for engaging an eyelet of the cover; and an actuator for moving the hook into engagement with the eyelet; and one or more indexers mounted to at least one of the main frame and the one or more latch assemblies, wherein each of the one or more indexers is configured for locating the main frame and/or the one or more latch assemblies relative to at least one of the cover and the barge in a length direction of the barge or a width direction of the barge.

Clause 2. The lifting device of clause 1, wherein at least one of the one or more indexers is configured to engage a top surface of the cover.

Clause 3. The lifting device of clause 1 or 2, wherein at least one of the one or more indexers is configured to be indexed relative to a topographical feature of the cover.

Clause 4. The lifting device of any of clauses 1-3, wherein at least one of the one or more indexers comprises a wheel configured to extend at least partially into a corrugation of the cover.

Clause 5. The lifting device of any of clauses 1-4, wherein at least one of the one or more indexers comprises a cover bumper that extends from the main frame and is configured for locating the main frame relative to the cover in the width direction of the barge.

Clause 6. The lifting device of any of clauses 1-5, wherein the cover bumper comprises an inclined surface configured to engage a side surface of the cover and guide the main frame into position as the main frame is lowered towards the cover.

Clause 7. The lifting device of any of clauses 1-6, wherein the cover bumper comprises a horizontal stop surface configured for contacting a top surface of the cover.

Clause 8. The lifting device of any of clauses 1-7, wherein the cover bumper hangs below the one or more latch assemblies.

Clause 9. The lifting device of any of clauses 1-8, wherein at least one of the one or more indexers comprises a locating arm configured for locating a front end or a rear end of the barge in the length direction of the barge.

Clause 10. The lifting device of any of clauses 1-9, wherein the locating arm is adjustable between a first position wherein the locating arm contacts the front end or the rear end of the barge, and a second position wherein the locating arm is spaced apart from the front end or the rear end of the barge.

Clause 11. The lifting device of any of clauses 1-10, further comprising an adjustment mechanism for moving the locating arm between the first position and the second position.

Clause 12. The lifting device of any of clauses 1-11, further comprising a sensor for detecting when the locating arm is in the first position.

Clause 13. The lifting device of any of clauses 1-12, wherein at least one of the one or more indexers comprises a barge bumper that extends from the one or more latch assemblies and is configured for locating the one or more latch assemblies relative to the barge in the width direction of the barge.

Clause 14. The lifting device of any of clauses 1-13, wherein the barge bumper comprises an inclined surface configured to engage the side surface of the barge and guide the one or more latch assemblies into position, and optionally holding the cover, as the main frame is lowered towards the cover.

Clause 15. The lifting device of any of clauses 1-14, wherein the one or more latch assemblies comprises a first pair of latch assemblies arranged on opposite ends of a first longitudinal side of the main frame, and a second pair of latch assemblies arranged on opposite ends of a second longitudinal side of the main frame.

Clause 16. The lifting device of any of clauses 1-15, wherein the one or more latch assemblies comprises at least two latch assemblies on a first longitudinal side of the main frame, and wherein at least one of the one or more indexers is disposed between the two latch assemblies on the first longitudinal side of the main frame.

Clause 17. The lifting device of any of clauses 1-16, wherein the actuator of each latch assembly is configured to move the hook of that latch assembly in a direction perpendicular to the fore and aft direction of the barge.

Clause 18. The lifting device of any of clauses 1-17, wherein the actuator comprises a linear actuator or a motor and a gearbox.

Clause 19. The lifting device of any of clauses 1-18, further comprising a barge finder extending laterally outward from the main frame in a width direction of the main frame, the barge finder comprising at least one pair of arms movably connected to the main frame, wherein the arms are independently movable relative to the main frame to align a central axis of the main frame with a central axis of the barge.

Clause 20. The lifting device of any of clauses 1-19, each arm comprises a first component movably mounted relative to the frame and a second component extending downwardly relative to the first component, and wherein the second component comprises a rod movably mounted within the second component.

Clause 21. A latch assembly for a barge cover lifting device, the latch assembly comprising: a guide channel; a hook slideable within the guide channel and configured for engaging an eyelet of the cover; and an actuator for moving the hook into engagement with the eyelet.

Clause 22. The latch assembly of clause 21, wherein the actuator comprises a linear actuator or a motor and a gearbox.

Clause 23. The latch assembly of clause 21 or 22, wherein the hook is slideable in a horizontal direction within the guide channel.

Clause 24. The latch assembly of any of clauses 21-23, wherein the hook comprises at least one prong configured to rotate the eyelet relative to the cover as the hook engages the eyelet.

Clause 25. The latch assembly of any of clauses 21-24, wherein the guide channel comprises a linear or roller bearing surface supporting an upper section of the hook.

Clause 26. The latch assembly of any of clauses 21-25, wherein the guide channel comprises a slot through which the hook extends downward.

Clause 27. The latch assembly of any of clauses 21-26, wherein the upper section of the hook that slides within the linear bearing surface has a round cross section.

Further details and advantages of the various embodiments or aspects described in detail herein will become clear upon reviewing the following detailed description of the various examples in conjunction with the accompanying drawing figures.

### BRIEF DESCRIPTION OF THE DRAWINGS

FIG. 1 is a side view of a lifting device shown on a cross-section of a barge according to some embodiments or aspects of the present disclosure;

FIG. 2 is a top view of the lifting device of FIG. 1;

FIG. 3 is a detailed side view of a latch assembly for use with a lifting device of FIG. 1, with the latch assembly shown in a first or latched position;

FIG. 4 is a detailed side view of the latch assembly of FIG. 3, with the latch assembly shown in a second or unlatched position;

FIG. 5 is a side view of a cover bumper for use with the lifting device of FIG. 1;

FIG. 6 is a side view of a barge bumper for use with the lifting device of FIG. 1;

FIG. 7 is a side view of a centering mechanism for use with a lifting device of FIG. 1; and

FIGS. 8A-8E are side views of the centering mechanism and the lifting device in various stages of lifting a cover from a barge.

### DETAILED DESCRIPTION OF THE DISCLOSURE

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures.

Spatial or directional terms, such as “left”, “right”, “inner”, “outer”, “above”, “below”, and the like, are not to be considered as limiting as the disclosure can assume various alternative orientations.

All numbers used in the specification and claims are to be understood as being modified in all instances by the term “about”. The terms “approximately”, “about”, and “substantially” mean a range of plus or minus ten percent of the stated value.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

As used herein, the term “at least one of” is synonymous with “one or more of”. For example, the phrase “at least one of A, B, and C” means any one of A, B, and C, or any combination of any two or more of A, B, and C. For example, “at least one of A, B, and C” includes one or more of A alone; or one or more B alone; or one or more of C alone; or one or more of A and one or more of B; or one or more of A and one or more of C; or one or more of B and one or more of C; or one or more of all of A, B, and C. Similarly, as used herein, the term “at least two of” is synonymous with “two or more of”. For example, the phrase “at least two of D, E, and F” means any combination of any two or more of D, E, and F. For example, “at least two of D, E, and F” includes one or more of D and one or more of E; or one or more of D and one or more of F; or one or more of E and one or more of F; or one or more of all of D, E, and F.

The word “comprising” and “comprises”, and the like, does not exclude the presence of elements or steps other than those listed in any claim or the specification as a whole. In the present specification, “comprises” means “includes” and “comprising” means “including”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular”, “transverse”, “substantially perpendicular”, or “substantially transverse” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

It is also to be understood that the specific devices and processes illustrated in the attached drawings, and described in the following specification, are simply exemplary embodiments or aspects of the disclosure. Hence, specific dimensions and other physical characteristics related to the examples disclosed herein are not to be considered as limiting.

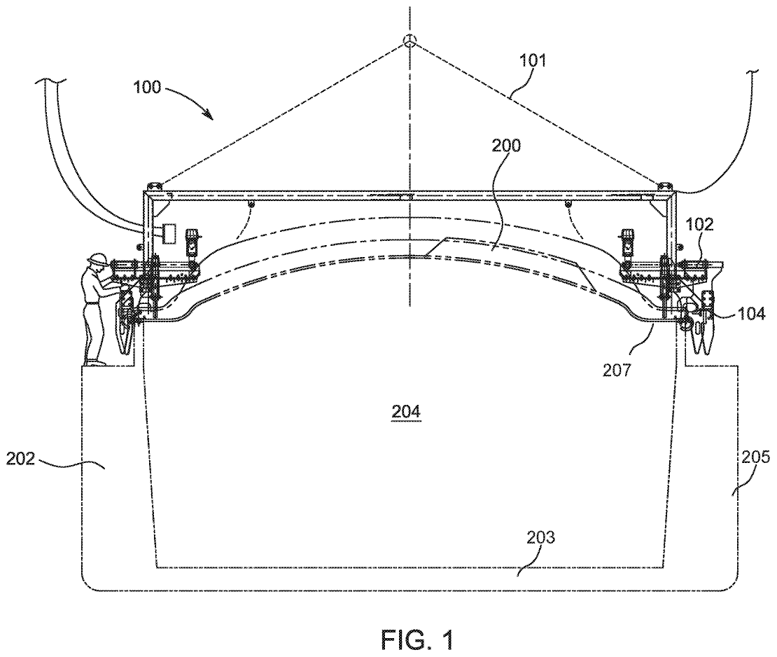

In some non-limiting embodiments or aspects of the present disclosure, and with reference to FIG. 1, a lifting device 100 is provided for lifting a cover 200 from a barge 202 and lowering the cover 200 onto the barge 202. The lifting device 100 is configured to be connected to a hoist (not shown) via one or more connecting lines 101. In this manner, the lifting device 100 may be maneuvered via the hoist to be aligned with the barge 202 and the cover 200 for lifting and lowering the cover 200 from and onto the barge 202.

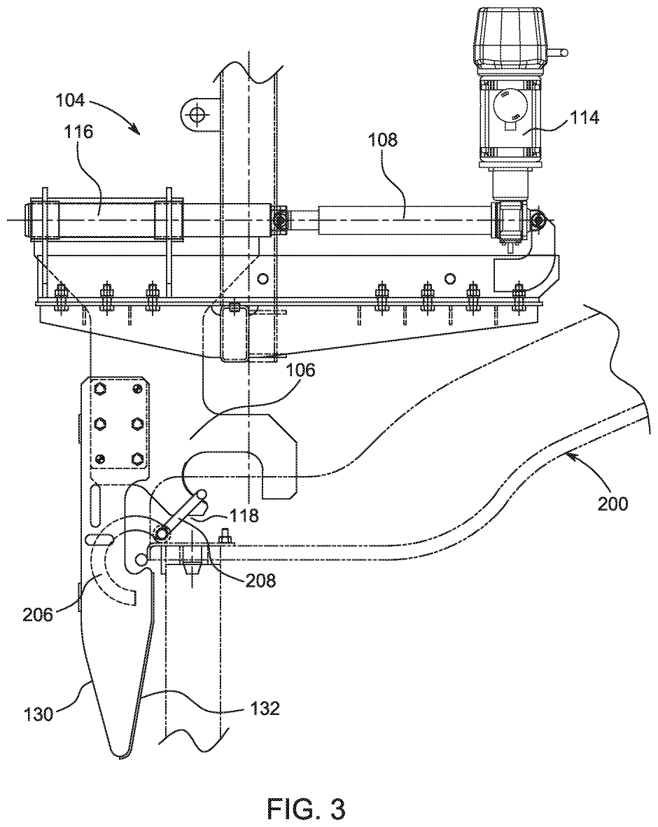

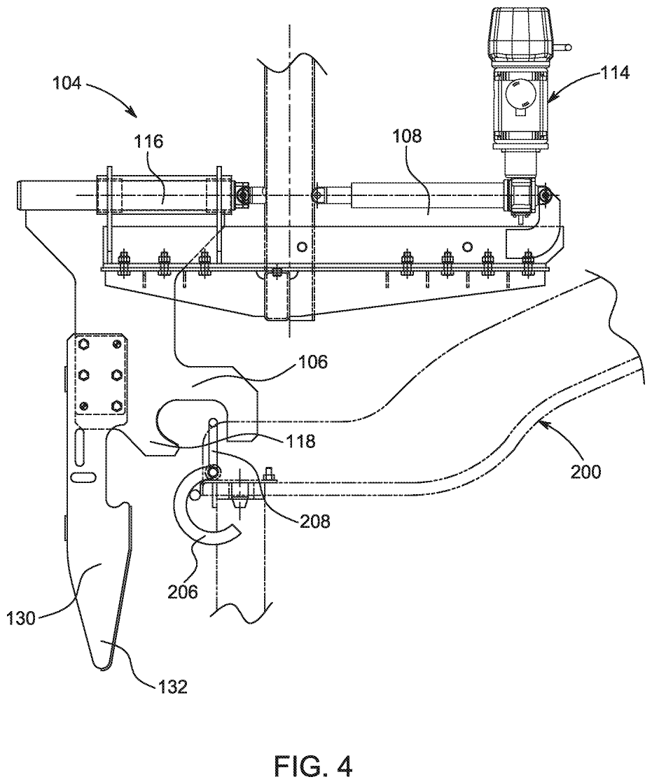

The barge 202 may be a river barge configured for transporting bulk material along waterways. The barge 202 has a floor 203 and sidewalls 205 extending vertically from the floor 203 to define an interior space 204. The barge 202 has an open top end 207 that may be enclosed when the cover 200 is placed on the barge 202. In this manner, the cover 200 is configured to enclose an interior space 204 of the barge 202 to keep the bulk material protected from outside elements. The cover 200 is generally made from a fiberglass composite material and has a substantially rectangular shape when viewed from the top. The cover 200 includes lifting rings 206 (shown in FIGS. 3-4) near each corner of the cover 200. Lifting rings 206 are connected to the cover 200 and serve a dual purpose—providing an attachment point for the lifting device during lifting of the cover 200 from the barge 202 and a hold down point for maintaining the cover 200 on the barge 202. The holding down, or the releasing, of the cover 200 to or from the barge 202 is effected by rotation of the lifting ring 206. When the lifting ring 206 is rotated, it disengages from the edge of the barge 202 to allow the cover 200 to be lifted.

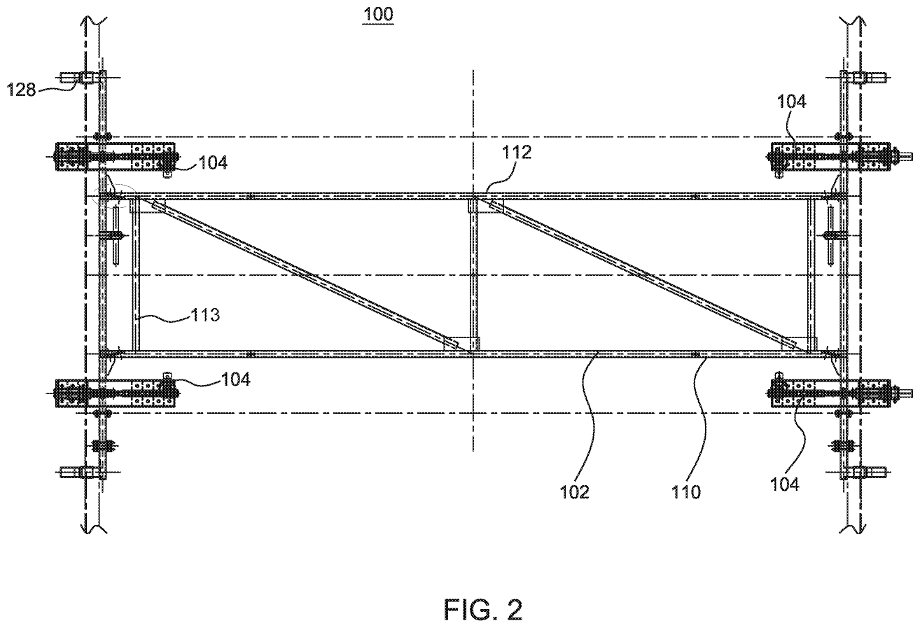

With reference to FIGS. 1-2, the lifting device 100 includes a main frame 102 and one or more latch assemblies 104 mounted to the main frame 102, with each of the latch assemblies 104 including a hook 106 (shown in FIGS. 3-4) for engaging an eyelet 208 on the lifting ring 206 of the cover 200. In some embodiments or aspects, the lifting device 100 has four latch assemblies 104 positioned at the corners of the main frame 102. Each of the latch assemblies 104 is positioned such that it can be located in proximity of the lifting rings 206 on the cover 200 when the lifting device 100 is placed on the cover 200 when the cover 200 is resting on the barge 202. In some embodiments or aspects, the lifting device 100 may have two latch assemblies 104 positioned at the corners of the main frame 102.

As shown in FIGS. 3-4, each latch assembly 104 includes an actuator 108 for moving the hook 106 into engagement with the eyelet 208 of the cover 200. As discussed herein, the lifting device 100 may further include one or more indexers mounted to at least one of the main frame 102 and the one or more latch assemblies 104. As discussed herein, each of the one or more indexers is configured for locating the main frame 102 and/or the one or more latch assemblies 106 relative to at least one of the cover 200 and the barge 202 in a length direction of the barge 202 or a width direction of the barge 202. In this manner, the lifting device 100 can be aligned relative to the cover 200 and the barge 202 when lifting the cover 200 from the barge 202 and/or lowering the cover 200 onto the barge 202.

In some non-limiting embodiments or aspects of the present disclosure, the one or more latch assemblies 104 may include a first pair of latch assemblies 104 arranged on opposite ends of a first longitudinal side 110 of the main frame 102, and a second pair of latch assemblies 104 arranged on opposite ends of a second longitudinal side 112 of the main frame 102 (shown in FIG. 2). The opposing longitudinal sides 110, 112 may be connected to each other via one or more connecting beams 113. At least one of the one or more indexers may be disposed between the two latch assemblies 104 on the first or second longitudinal sides 110, 112 of the main frame 102.

In some non-limiting embodiments or aspects of the present disclosure, and with reference to FIGS. 3-4, the actuator 108 of each latch assembly 104 may be configured to move the hook 106 of that latch assembly 104 in a direction perpendicular to the fore and aft direction of the barge 202 (i.e., direction in and out of the page in FIGS. 3-4). The actuator 108 may include a linear actuator that is powered by an electric motor 114. In some examples or aspects, the actuator 108 may be a pneumatic or a hydraulic rod. In further examples or aspects, the actuator 108 may include a motor and gearbox. The motor and gearbox may be operatively connected via cranks and links.

With continued reference to FIGS. 3-4, the hook 106 of each of the latch assemblies 104 may be slidably mounted within a guide channel 116 such that the hook 106 is movable in a direction of arrow A shown in FIG. 3. The hook 106 of each of the latch assemblies 104 may include at least one prong 118 configured to rotate the eyelet 208 relative to the cover 200 as the hook 106 engages the eyelet 208. The guide channel 116 may include a linear or roller bearing surface supporting an upper section of the hook 106. In some examples or aspects, the hook 106 may be supported on rollers with flanges. The guide channel 116 may include a slot through which the hook 106 extends downward. In some embodiments or aspects, at least a portion of the hook 106 may be supported in the guide channel 116 by bearings, such as linear bearings. The upper section of the hook 106 that slides within the bearing may have a round cross section.

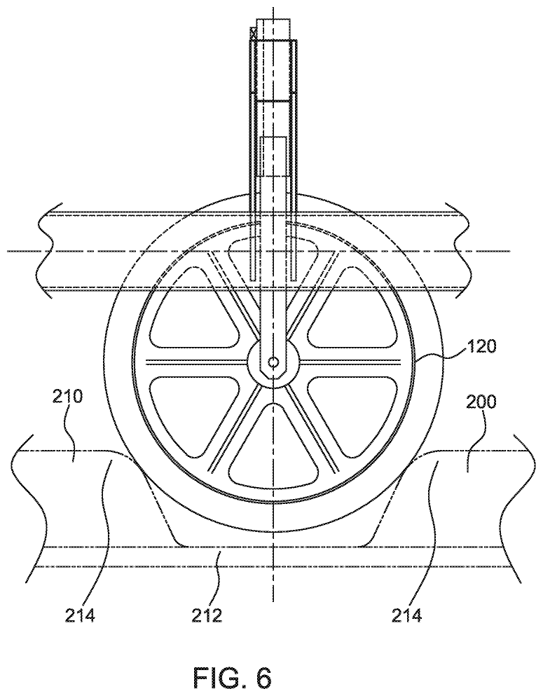

In some non-limiting embodiments or aspects of the present disclosure, at least one of the one or more indexers may be configured to engage a top surface 210 of the cover 200 (shown in FIG. 6). At least one of the one or more indexers may be configured to be indexed relative to a topographical feature of the cover. For example, and with reference to FIG. 6, at least one of the one or more indexers may include a wheel 120 configured to extend at least partially into a corrugation 212 between adjacent protrusions 214 of the cover 200. Once the wheel 120 is positioned in the corrugation 212 such that the one or more latch assemblies 104 are aligned with respective eyelets 208 on the cover 200, the lifting device 100 is aligned relative to the cover 200 in a fore and aft direction of the barge 202. In other embodiments or aspects, the wheel 120 may be replaced with another feature configured for locating the lifting device 100 relative to the cover 200 based on a topographical feature of the cover 200, such as the corrugation 212 and the adjacent protrusions 214.

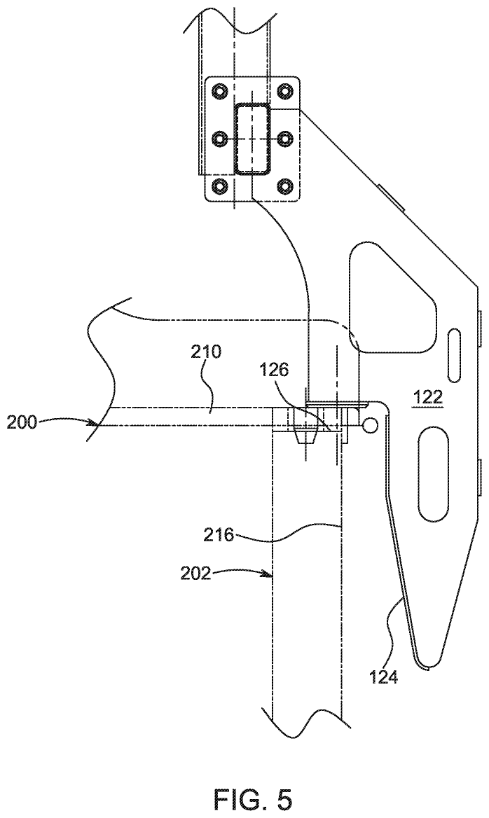

In some non-limiting embodiments or aspects of the present disclosure, and with reference to FIG. 5, at least one of the one or more indexers may include a cover bumper 122 that extends from the main frame 102 and is configured for locating the main frame 102 relative to the cover 200 in a width direction of the barge 202. The cover bumper 122 may include an inclined surface 124 configured to engage a side surface of the cover 200 during lowering of the main frame 102 toward the cover 200. If the main frame 102 is misaligned relative to the cover 200 in the width direction of the cover 200, the inclined surface 124 urges the main frame 102 into proper alignment with the cover 200 as the main frame 102 is lowered onto the cover 200. The cover bumper 122 may further include a horizontal stop surface 126 configured for contacting a top surface 210 of the cover 200. The cover bumper 122 may hang below the one or more latch assemblies 104. In some embodiments or aspects, the cover bumper 122 may have an adjustment mechanism for adjusting a width of opposing cover bumpers 122 to account for different sized covers 200. The adjustment mechanism may be motorized.

In some non-limiting embodiments or aspects of the present disclosure, and with reference to FIG. 2, at least one of the one or more indexers may include a locating arm 128 configured for locating a front end or a rear end of the main frame 102 in the length direction of the barge 202. The locating arm 128 may be adjustable between a first position wherein the locating arm 128 contacts the front end or the rear end of the barge 202, and a second position wherein the locating arm 128 is spaced apart from the front end or the rear end of the barge 202. An adjustment mechanism may be provided for moving the locating arm between the first position and the second position. A sensor may detect when the locating arm is in the first position.

With reference to FIGS. 3-4, at least one of the one or more indexers may include a barge bumper 130 that extends from the one or more latch assemblies 104 and is configured for locating the one or more latch assemblies 104 relative to the barge 202 in the width direction of the barge 202. The barge bumper 130 may include an inclined surface 132 configured to engage a side surface 212 of the barge 202 and guide the one or more latch assemblies 104 into position as the main frame 102 is lowered towards the barge 202.

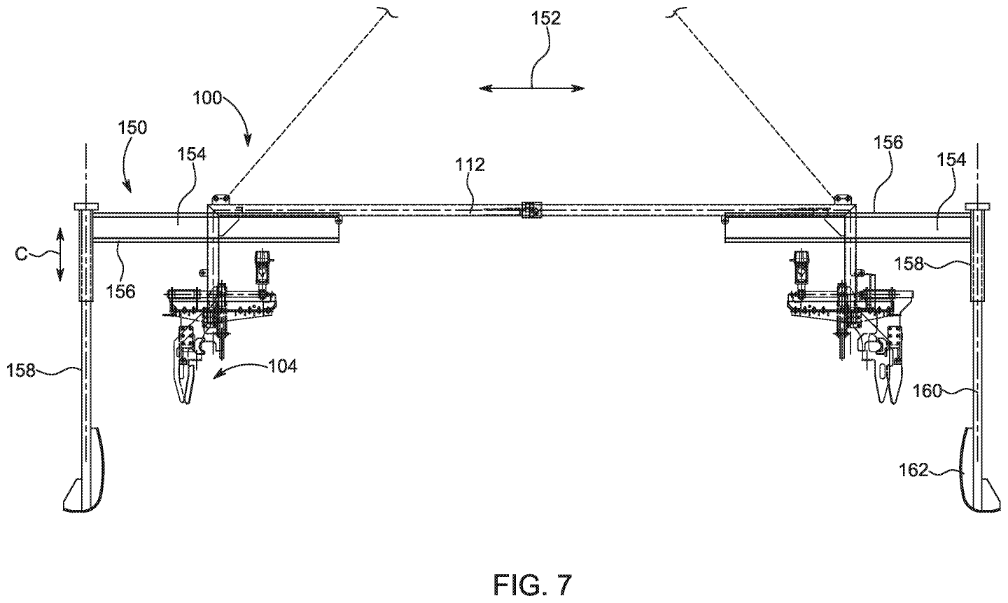

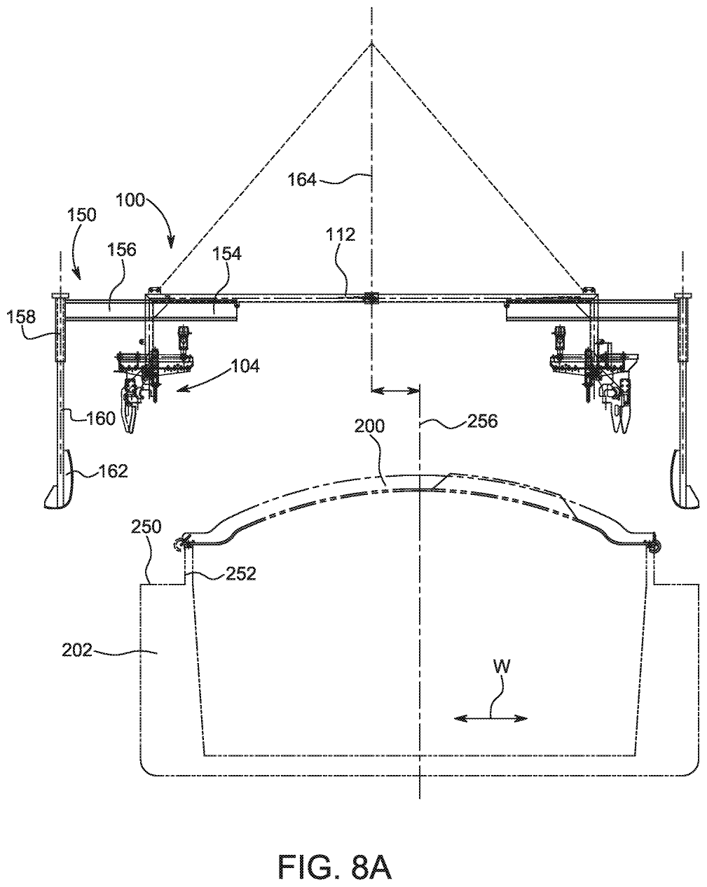

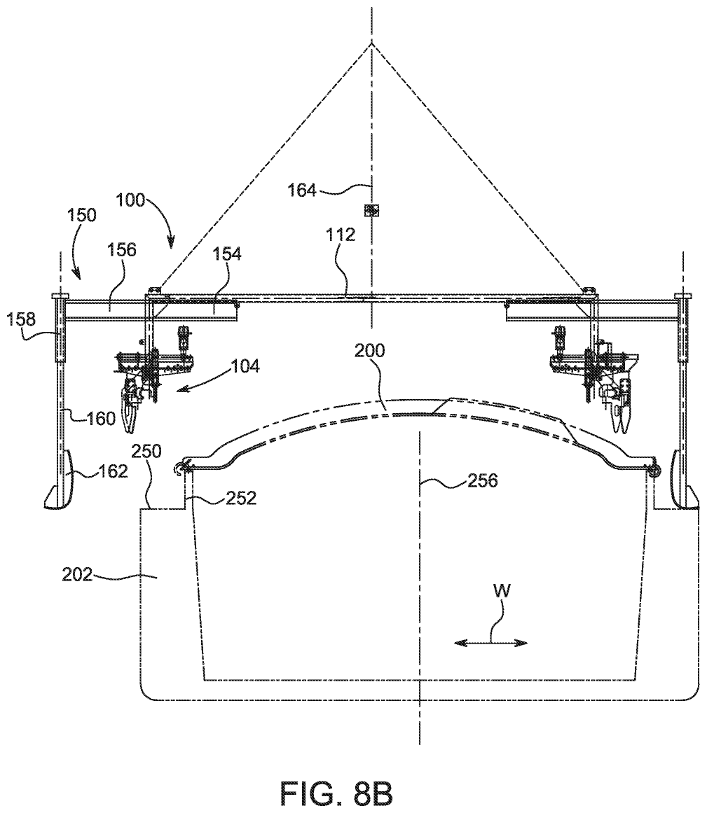

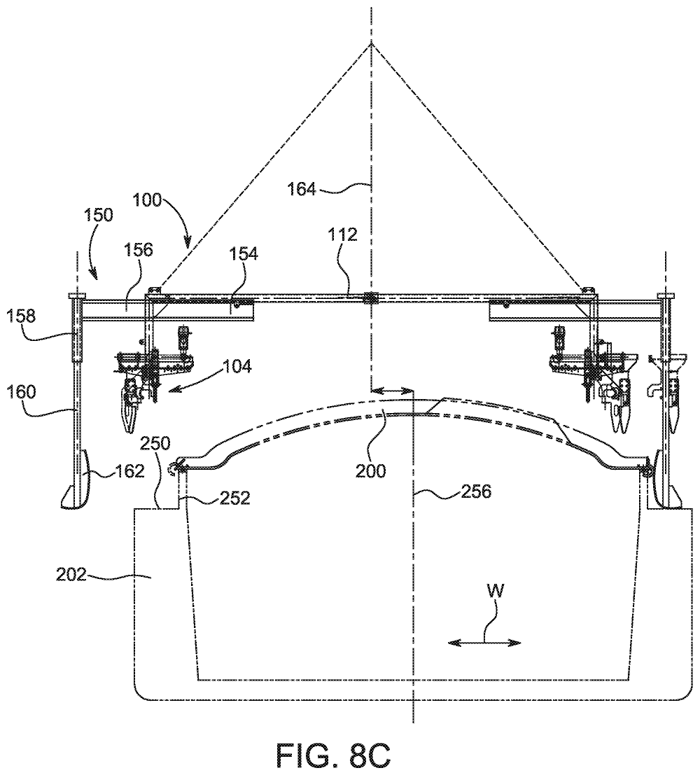

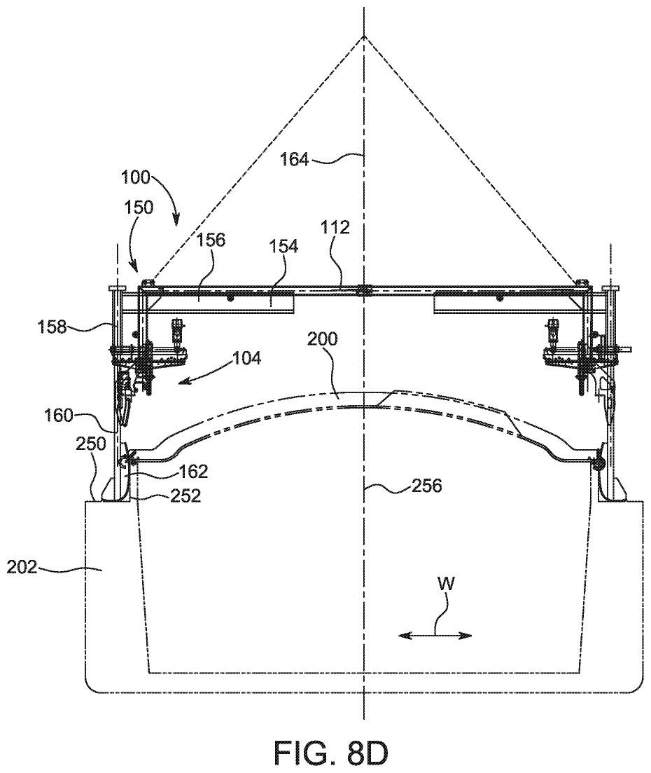

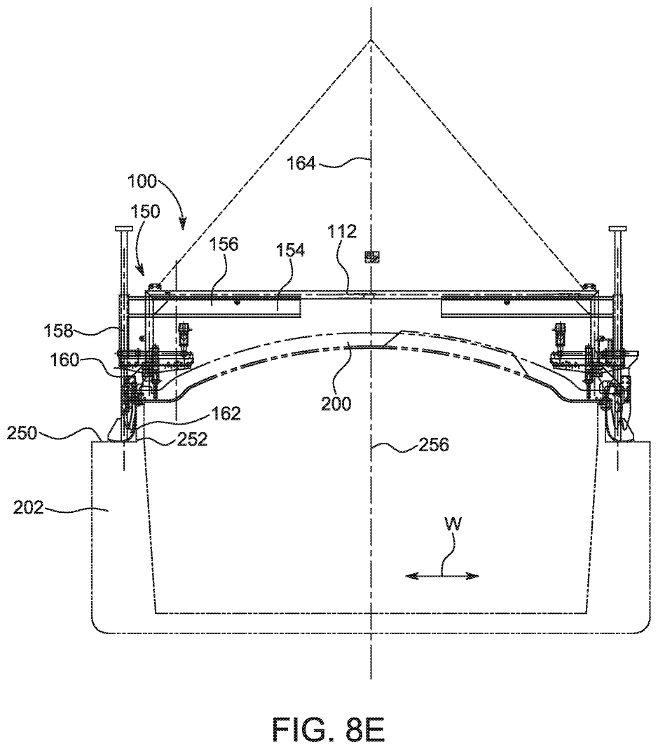

With reference to FIG. 7, at least one of the one or more indexers may include a barge finder 150 that extends laterally outward from the main frame 112 in a width direction 152 of the frame. In some embodiments or aspects, the barge finder 150 may be configured for locating the main frame 112 of the lifting device 100 relative to the barge 202 in the width direction W of the barge 202 (shown in FIGS. 8A-8E). The barge finder 150 may include a pair of arms 154 movably connected to the main frame 112. Each of the arms 154 may be independently movable relative to the main frame 154 in the width direction 152. For example, independent actuators, such as electric motors, may be provided for moving the arms 154 relative to the main frame 112. In some embodiments or aspects, the lifting device 100 may have two pairs of arms 154, with one pair of arms 154 located at a first portion of the main frame 112, such as the left-hand side of the main frame 112 shown in FIG. 2, and the other pair of arms 154 located at an opposing second portion of the main frame 112, such as the right-hand side of the main frame 112 shown in FIG. 2.

With continued reference to FIG. 7, each arm 154 has a first component 156 that is movably mounted to the main frame 112 and a second component 158 that extends downwardly from a terminal end of the first component 156. The second component 158 receives a rod 160 that is movable in a direction of arrow C relative to the second component 158. In some embodiments or aspects, movement of the rod 160 may be controlled by an actuator, such as an electric motor. The rod 160 may have a pad 162 configured for contacting a portion of the barge 202.

With reference to FIGS. 8A-8E, a process of moving the lifting device 100 onto the barge 202 to remove the cover 200 will now be described. The same process could be carried out for lowering the cover 200 on the barge 200. Initially, as shown in FIGS. 8A-8B, the lifting device 100 is lowered onto a ledge 250 of the barge 202 such that at least a portion of the lifting device 100 contacts the ledge 250 of the barge 202. In some examples or aspects, the main frame 112 may be lowered toward the barge 202 until the pad 162 of the rod 160 touches the ledge 250. With reference to FIGS. 8C-8D, the arms 152 are then moved in the direction of arrow B in order to locate the main frame 112 relative to the width direction W of the barge 202. This movement allows a central axis 164 of the lifting device 100 to be aligned with a central axis 256 of the barge 202. In this manner, the width of the lifting device 100 can be adjusted so that the lifting device 100 can be used with barges 202 having different width. When both pads 162 contact the ledge 250 of the barge 202 and a sidewall 252 extending vertically upward from the ledge 250, the main frame 112 has been located in the width direction of the barge 202. With reference to FIG. 8E, the main frame 112 can then be lowered toward the cover 200 by moving the rod 160 relative to the second component 158 of the arm 154. Movement of the main frame 112 may be stopped once at least a portion of the lifting device 100 engages the top surface of the cover 200. The lifting device 100 may then be operated to connect to the lifting rings 206 of the cover 200, as described herein.

While various embodiments or aspects of the cover lifter were provided in the foregoing description, those skilled in the art may make modifications and alterations to these examples without departing from the scope and spirit of the disclosure. Accordingly, the foregoing description is intended to be illustrative rather than restrictive. The disclosure described hereinabove is defined by the appended claims, and all changes to the disclosure that fall within the meaning and the range of equivalency of the claims are to be embraced within their scope.

1. A lifting device configured for lifting a cover from a barge and lowering the cover onto the barge, the lifting device comprising:
a main frame;
one or more latch assemblies mounted to the main frame, each of the latch assemblies comprising:
a hook for engaging an eyelet on the cover; and
an actuator for moving the hook into engagement with the eyelet; and
one or more indexers mounted to at least one of the main frame and the one or more latch assemblies,
wherein each of the one or more indexers is configured for locating the main frame and/or the one or more latch assemblies relative to at least one of the cover and the barge in a length direction of the barge or a width direction of the barge.

2. The lifting device of claim 1, wherein at least one of the one or more indexers is configured to engage a top surface of the cover.

3. The lifting device of claim 1, wherein at least one of the one or more indexers is configured to be indexed relative to a topographical feature of the cover.

4. The lifting device of claim 3, wherein at least one of the one or more indexers comprises a wheel configured to extend at least partially into a corrugation of the cover.

5. The lifting device of claim 1, wherein at least one of the one or more indexers comprises a cover bumper that extends from the main frame and is configured for locating the main frame relative to the cover in the width direction of the barge.

6. The lifting device of claim 5, wherein the cover bumper comprises an inclined surface configured to engage a side surface of the cover and guide the main frame into position as the main frame is lowered towards the cover.

7. The lifting device of claim 5, wherein the cover bumper comprises a horizontal stop surface configured for contacting a top surface of the cover.

8. The lifting device of claim 5, wherein the cover bumper hangs below the one or more latch assemblies.

9. The lifting device of claim 1, wherein at least one of the one or more indexers comprises a locating arm configured for locating a front end or a rear end of the barge in the length direction of the barge.

10. The lifting device of claim 9, wherein the locating arm is adjustable between a first position wherein the locating arm contacts the front end or the rear end of the barge, and a second position wherein the locating arm is spaced apart from the front end or the rear end of the barge.

11. The lifting device of claim 10, further comprising an adjustment mechanism for moving the locating arm between the first position and the second position.

12. The lifting device of claim 10, further comprising a sensor for detecting when the locating arm is in the first position.

13. The lifting device of claim 1, wherein at least one of the one or more indexers comprises a cover bumper that extends from the one or more latch assemblies and is configured for locating the one or more latch assemblies relative to the cover in the width direction of the barge.

14. The lifting device of claim 13, wherein the cover bumper comprises an inclined surface configured to engage the cover and guide the one or more latch assemblies into position as the main frame is lowered towards the cover.

15. The lifting device of claim 1, wherein the one or more latch assemblies comprises a first pair of latch assemblies arranged on opposite ends of a first longitudinal side of the main frame, and a second pair of latch assemblies arranged on opposite ends of a second longitudinal side of the main frame.

16. The lifting device of claim 1, wherein the one or more latch assemblies comprise at least two latch assemblies on a first longitudinal side of the main frame, and
wherein at least one of the one or more indexers is disposed between the two latch assemblies on the first longitudinal side of the main frame.

17. The lifting device of claim 1, wherein the actuator of each latch assembly is configured to move the hook of that latch assembly in a direction perpendicular to the fore and aft direction of the barge.

18. The lifting device of claim 1, wherein the actuator comprises a linear actuator or a motor and a gearbox.

19. The lifting device of claim 1, further comprising a barge finder extending laterally outward from the main frame in a width direction of the main frame, the barge finder comprising at least one pair of arms movably connected to the main frame, wherein the arms are independently movable relative to the main frame to align a central axis of the main frame with a central axis of the barge.

20. The lifting device of claim 19, wherein each arm comprises a first component movably mounted relative to the frame and a second component extending downwardly relative to the first component, and wherein the second component comprises a rod movably mounted within the second component.
